(19) United States
(12) Patent Application Publication
(10) Pub. No.: US 2016/0171534 A1
(43) Pub. Date: Jun. 16, 2016

(54) INFERRING PRODUCT INTEREST

(71) Applicant: Facebook, Inc., Menlo Park, CA (US)

(72) Inventors: Lee Charles Linden, San Francisco, CA (US); Benjamin Lewis, San Francisco, CA (US); Dwight Ewing Crow, San Francisco, CA (US); Jonathan Shottan, San Francisco, CA (US); Peng Fan, Castro Valley, CA (US)

(21) Appl. No.: 14/567,691

(22) Filed: Dec. 11, 2014

(51) Int. Cl. G06Q 30/02; G06Q 50/00

(52) U.S. Cl. CPC G06Q 30/0255; G06Q 50/01

(57) ABSTRACT

The present disclosure relates, in part, to a system for inferring user interest in new products based on a history of product purchases. In particular, an interest inference system can monitor a plurality of purchases by users and identify product attributes and user attributes from information associated with the purchases. The interest inference system can further determine correlations between product attributes and user attributes. Based on the correlations, the interest inference system can identify users that are likely to be interested in a new product even if no past marketing data is available for the new product.

### BACKGROUND

1. Technical Field

One or more embodiments relate generally to an online social networking system. More specifically, one or more embodiments relate to inferring product interest of social networking system users based on attributes associated with users and products.

2. Background and Relevant Art

A social networking system allows its users to connect to and communicate with other social networking system users. Each user may create a profile on a social networking system that corresponds to a user identity and may include information about each specific user, such as interests and demographic information. Because of the increasing popularity of social networking systems, as well as the increasing amount of user-specific information to which a social networking system has access, a social networking system may provide an ideal forum for advertisers to increase awareness about products or services.

Generally, advertisers may include third-party merchants (e.g., entities separate from the provider of a social networking system). Many merchants provide marketing content (e.g., through websites and mobile applications) to promote and sell products and/or services outside of the social networking system. Merchants may desire to advertise to users within a social networking system to drive more user traffic to the merchant's content. For example, presenting advertisements to users within a social networking system can allow a merchant to gain increased awareness for its products and/or services.

Conventionally, a merchant can track an individual user's activity with respect to the merchant's content (e.g., website, application), however, the merchant generally lacks any additional information about the user that would be helpful in advertising the merchant's products to the user, or to other potential customers, based on activity of the individual user. More often than not, a merchant's best opportunity to use an individual user's activity with respect to merchant content is to send a follow-up communication to the individual user, assuming the merchant has an email address or physical address for the user. Therefore, the merchant's advertising activities are often inefficient, limited in nature, and/or lack accurate targeting to customers.

In addition to advertising to a user based on the user's tracked activity, many merchants provide targeted advertising to a user based on a tracked purchase (e.g., purchase history) of that user and tracked purchases of other users who have made identical purchases as the user. For example, where a user has purchased a product, many merchants provide targeted advertising to the user for related products based on subsequent purchases of other users who have purchased the same product. Nevertheless, while advertising to a user based on a purchase history of the user or other users may result in efficient marketing for products having an extensive purchase history, many merchants are unable to predict who will be interested in a new product or accurately determine how successful marketing a new product will be. As such, many merchants provide ineffective or inefficient marketing for new products until an extensive history of purchases can be accumulated for the new products.

Accordingly, there are a number of disadvantages with conventional methods of providing targeted advertising to users of a social network.

### SUMMARY

One or more embodiments described herein provide benefits and/or solve one or more of the foregoing problems in the art with systems and methods for inferring interest in products based on product and/or user attributes. For example, one or more embodiments include systems and methods for monitoring purchases by users of a system (e.g., a social networking system), and identifying product attributes and user attributes associated with the monitored purchases and determining correlations between product attributes and user or user attributes. The system can then receive attribute information for a new product and identify one or more users having a potential interest in the new product based on one or more of the correlations between product attributes and users/user attributes.

In one or more embodiments, using product attribute correlations to infer interest in a product can facilitate an accurate prediction of user interest in a product associated with a limited purchase history. In other words, using the product attribute correlations, the disclosed system is able to predict/infer interest in a product even without information that is specific to the product and indicates which users might be interested in the product. For example, the system disclosed herein can facilitate inferring an interest of a user in a new product having a limited or no purchase history or, for which no direct user interest data is available. In particular, based on correlations between product attributes associated with the new product and corresponding users/user attributes, the system can identify users that will potentially be interested in the new product even though limited or no past purchase information is available for the new product. In other words, the system can facilitate an accurate prediction that one or more users will likely purchase or otherwise have a heightened interest in a new product based on attributes of the new product.

In one or more embodiments, inferring interest in new products using attribute correlations can provide effective marketing based on personal information associated with users. For example, an interest inference system (or simply “system”) can identify user attributes associated with a user in determining an interest of the user in a product. In some embodiments, one or more user attributes can provide an indication as to whether a user has a prospective interest in a product having certain product attributes. Further, the system can infer user interest in a product based primarily on user attributes associated with a user without requiring an extensive purchase history for the user. Thus, the systems and methods described herein can facilitate an accurate prediction of whether a user will have an interest in a product based on user attributes and other personal information associated with the user without having access to a history of purchases associated with the user.

Additional features and advantages of the embodiments will be set forth in the description that follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a schematic diagram of a system for inferring product interest in accordance with one or more embodiments of the present disclosure;

FIG. 2 illustrates a block diagram of an example environment for implementing the system of FIG. 1 in accordance with one or more embodiments of the present disclosure;

FIG. 3 illustrates a block diagram of an example record of product purchases in accordance with one or more embodiments of the present disclosure;

FIG. 4 illustrates a block diagram of an example record of correlations in accordance with one or more embodiments of the present disclosure;

FIG. 5 illustrates a flow diagram of a method of inferring product interest in accordance with one or more embodiments of the present disclosure;

FIG. 6 illustrates a block diagram of an exemplary computing device in accordance with one or more embodiments of the present disclosure;

FIG. 7 illustrates an example network environment of a social networking system in accordance with one or more embodiments of the present disclosure; and

FIG. 8 illustrates a social graph in accordance with one or more embodiments.

### DETAILED DESCRIPTION

One or more embodiments of the present disclosure relate to systems and methods for inferring interest in products based on attributes associated with a history of product purchases by users of a social networking system. In particular, one or more embodiments more accurately identify users having an interest in products based on attributes associated with the users and/or products. For instance, a product interest inference system (or simply “system”) can monitor purchases by a plurality of users and identify one or more product attributes and/or user attributes associated with the purchases. The system can further determine attribute correlations between the users/user attributes and product attributes based on the identified user attributes and product attributes associated with the purchases.

Using the determined attribute correlations, the system can accurately identify users having a prospective interest in a new product. For example, the system can receive one or more product attributes of a new product. The system can identify one or more of the attribute correlations associated with the one or more attributes of the new product. Further, the system can identify a target group of users based on the one or more identified attribute correlations associated with the new product attributes. In particular, the system can infer interest for a target group of users in a new product based on one or more correlations between the one or more product attributes of the new product and the target group of users, as will be explained in more detail below.

Inferring interest in products using correlations can facilitate effective marketing based on personal information associated with users. In particular, the system can identify and manage user attributes based on personal information associated with users of a social networking system. For example, the system can use different user attributes (e.g., gender, age, income) to accurately infer an interest of a user or particular demographic of user in an existing or new product. Inferring product interest based on user attributes can enable effective prediction of user interest in a product. Additionally, the system can accurately predict interest of a particular demographic of users based on user attributes in common between multiple users. In this way, a merchant or provider of advertising content can more effectively provide targeted advertising to a group of users or particular demographic of users who are more likely to purchase a product.

Additionally, using attribute correlations between user attributes and product attributes can facilitate effective marketing without requiring an extensive purchase history associated with a particular product. For example, where a new product has a limited purchase history, the system can accurately predict a user interest in a new product without an extensive purchase history associated with the new product. In particular, the system can receive product attributes (e.g., price, brand, appearance) associated with a new product from a merchant. Using the received product attributes, the system can identify or infer interest of a user in the new product based on a correlation between the received product attributes and the user or attributes of the user. The system can thus facilitate effective targeted marketing to a user or group of users having one or a combination of particular attributes without having access to a purchase history associated with the new product.

As used herein, the term “targeted marketing” or “targeted advertising” refers to content that is selected and/or provided to one or more users based on correlations between product attributes and the one or more users. For example, targeted marketing includes identifying an interest, or likely interest, of a user, and providing marketing content based upon a known correlation between the one or more users and the attributes of a product being marketed.

In addition, as used herein, the term “content” refers to any form of digital data that may be transmitted over a communication network. For example, content can include, but is not limited to, web sites, web pages, digital media (e.g., audio, video, images), electronic documents, electronic communication messages, or any other digital content or combination of digital content. In addition, the term “third-party content” refers to content that is provided by a content source that is outside of a social networking system.

The term “product” or “products,” as used herein, refers to both goods and services provided by one or more merchants. For example, a product can refer to a tangible good as well as a service.

The term “attribute” or “attributes,” as used herein, refers to characteristics and/or features of products and/or users. For example, a “user attribute” can refer to one or a combination of characteristics and/or features associated with a user of a social networking system. Examples of user attributes may include various user characteristics, such as age (e.g., age range), gender, income (e.g., income range), or other personal information accessible to a social networking system. For example, user attributes may include any information from a user profile (e.g., social networking profile), such as demographic information (e.g., age, race, gender), profession, income, family size, household size, religious affiliation, relationship status, physical characteristics, education, birthday, number of friends, identity of friends, household size, where a user is born and raised, where a user went to school, or other information that is personal to the user. In some examples, the user attributes can be based on social networking activity. For example, user attributes can be derived from check-ins, “likes,” social networking connections, life events (e.g., birth date and/or location, “lived in” dates and locations, graduated date and educational institutions, and/or any other events listed on a user's social networking timeline), comments, social networking posts, and/or any other attributes derived from social networking activities.

Additionally, a “product attribute” can refer to one or a combination of characteristics and/or features associated with a product. Examples of product attributes may include various product characteristics, such as price, brand, appearance, design, color, size, product category/type, material(s) in product, keywords associated with product, capabilities, product weight, product dimensions, country of origin, capacity, product release date, product features, product warranty, and/or other features or characteristics associated with or descriptive of a particular product. To illustrate, product attributes for a computing device may include screen size, screen resolution, processor, RAM, hard drive type and/or size, graphics card, wireless capabilities/technologies, battery life and/or type, brand, operating system, weight, dimensions, color, number and/or type of ports, and/or any other attributes associated with a computing device. Similarly, product attributes for any other product can represent any characteristics/information associated with and/or specific to the product.

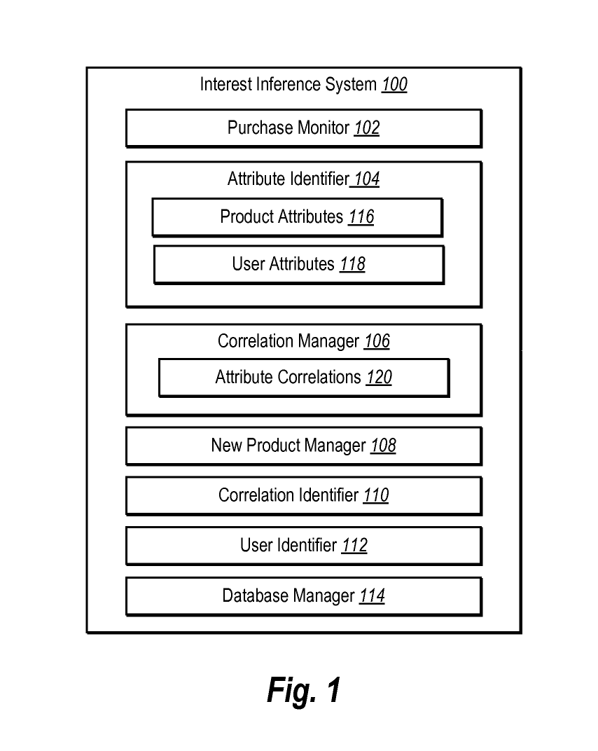

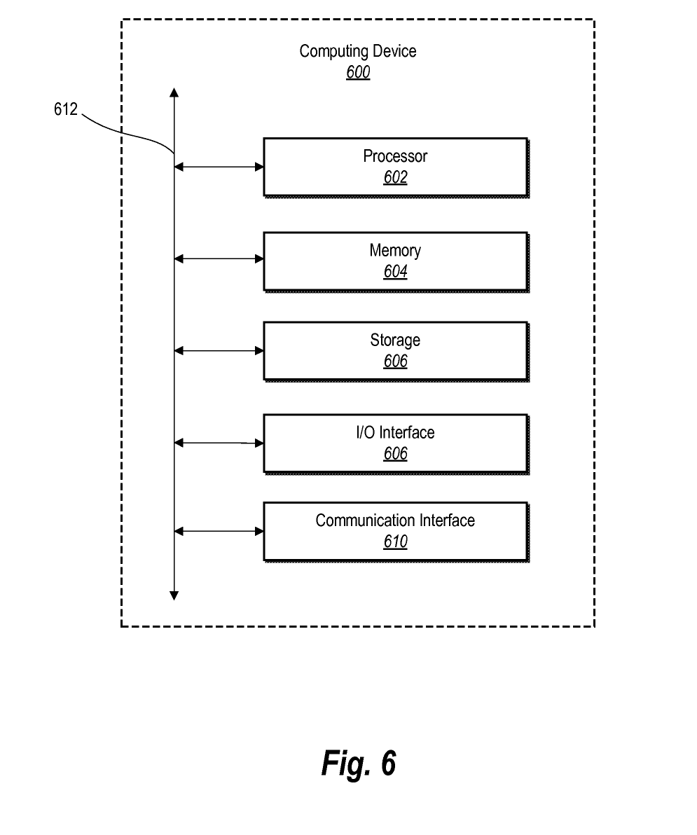

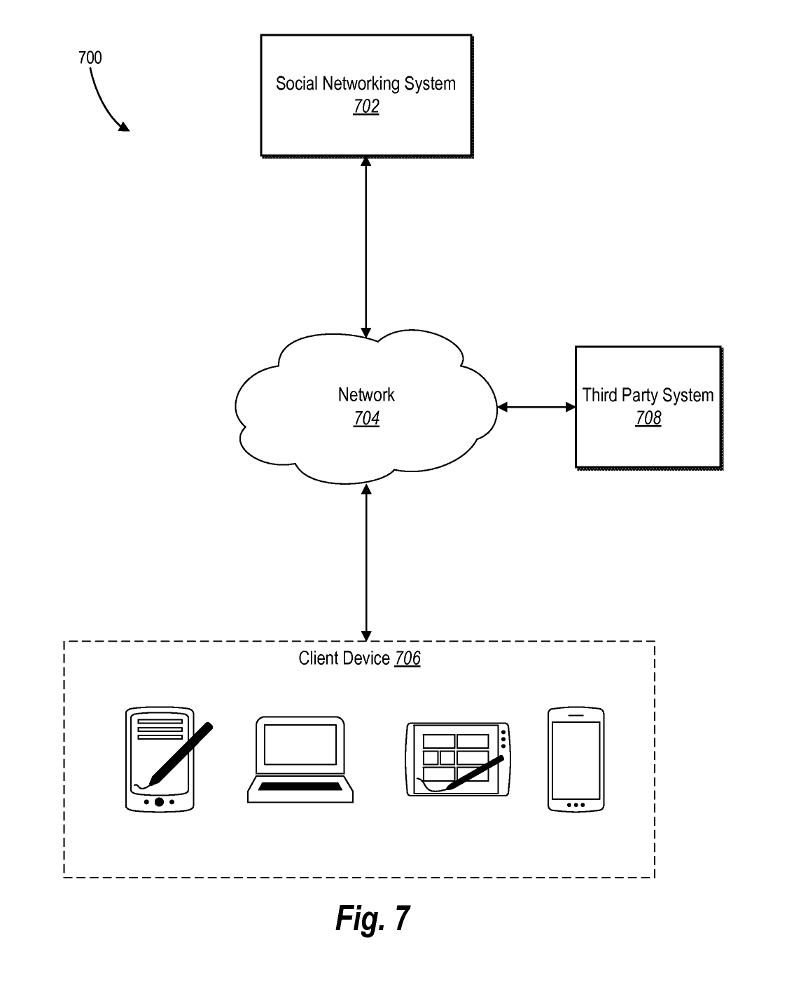

FIG. 1 illustrates an example embodiment of an interest inference system 100 (or simply “system”) in accordance with one or more principles described herein. As shown in FIG. 1, the system 100 includes a purchase monitor 102, an attribute identifier 104, a correlation manager 106, a new product manager 108, a correlation identifier 110, a user identifier 112, and a database manager 114. It will be recognized that components 102-114 can be combined into fewer components, such as into a single component, or divided into more components as may serve a particular embodiment. Additionally, components 102-114 can be located on, or implemented by, a single computing device (e.g., a server device) or by multiple computing devices, such as those described below in relation to FIG. 6. Alternatively, portions of the system 100 can be implemented on a client device, while other portions of the system 100 can be implemented on a social networking system, such as described below in reference to FIG. 7.

The components 102-114 can include software, hardware, or a combination thereof. For example, the components 102-114 can include one or more instructions stored on a computer-readable storage medium and executable by one or more processors of one or more computing devices. When executed by the one or more processors, the computer-executable instructions of the system 100 can cause a computing device to perform the methods described herein. Alternatively, the components 102-114 can comprise hardware, such as a special purpose processing device to perform a certain function or group of functions. Additionally or alternatively, the components 102-114 can include a combination of computer-executable instructions and hardware.

As mentioned above, and as shown in FIG. 1, the system 100 can include a purchase monitor 102. The purchase monitor 102 can monitor and/or manage purchases of various products by various users. In particular, the purchase monitor 102 can monitor purchases of one or more products by users of a social networking system. In some embodiments, the purchase monitor 102 can monitor purchases made by users via the social networking system. Alternatively, the purchase monitor 102 can monitor purchases by users using other systems and/or websites (e.g., third-party merchant websites). As used herein, the term “monitoring purchases” also includes monitoring responses to product advertisements, monitoring social networking activities related to products (e.g., “likes,” follows, comments, etc.), and monitoring any other activities indicating interest in one or more products.

In monitoring and/or managing various purchases, the purchase monitor 102 may obtain and/or otherwise access purchase information associated with each of the purchases. In particular, the purchase monitor 102 can obtain information associated with a user of a purchase. The purchase monitor 102 can also obtain information associated with a product purchased by the user. In some embodiments, the purchase monitor 102 can obtain purchase information by tracking purchases made by a user using the social networking system or, alternatively, using other systems and/or websites. Additionally or alternatively, the purchase monitor 102 can receive purchase information from the social networking system and/or from a third-party server.

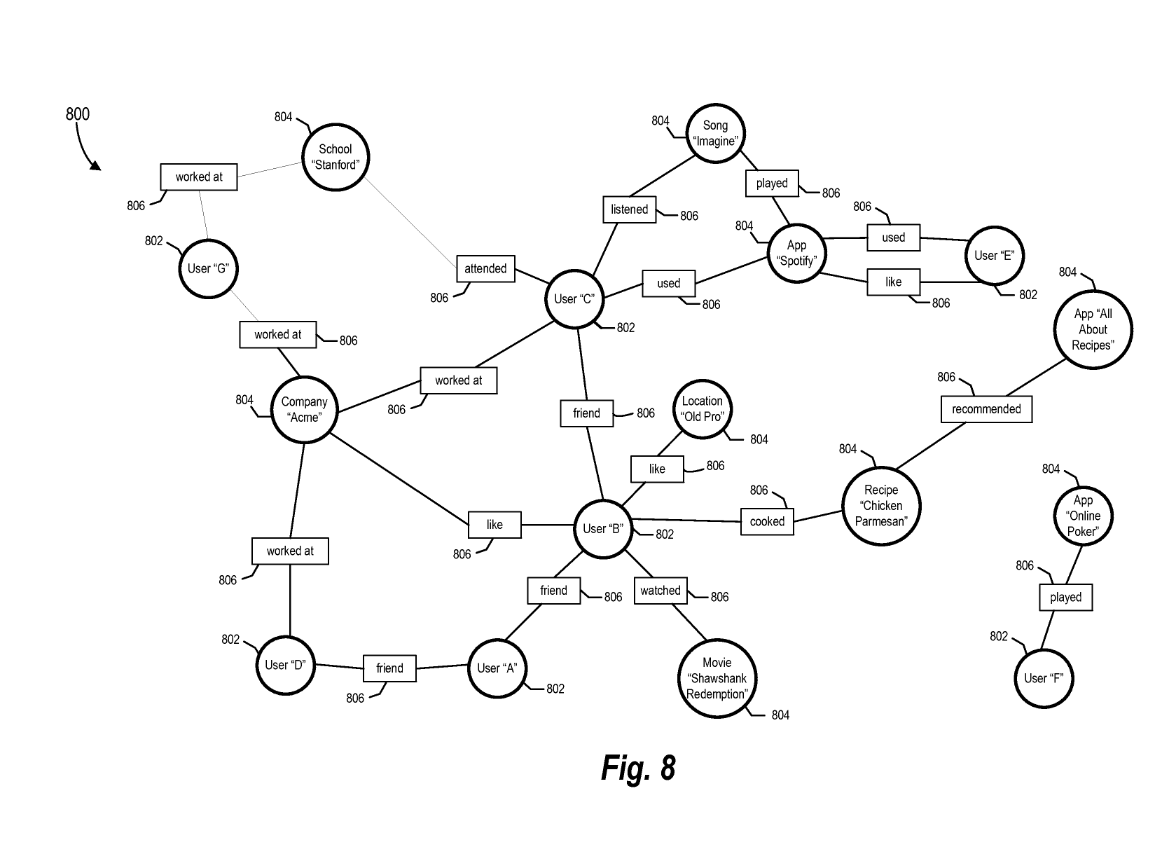

In obtaining purchase information, the purchase monitor 102 can access information from various sources. For example, the purchase monitor 102 may obtain purchase information associated from a user profile or other information provided by the user (e.g., using the social networking system). Additionally or alternatively, the purchase monitor 102 can receive purchase information from a third-party server. In some embodiments, the purchase monitor 102 can access information for a user from a user node associated with the user within a social graph. Similarly, the purchase monitor 102 can access information for a product from a corresponding product node within the social graph, as explained in more detail below with respect to FIG. 8.

In addition to obtaining the purchase information, the purchase monitor 102 can also store the purchase information on a database. For example, the purchase monitor 102 can store data associated with each purchase in a database accessible to one or more components 102-114 of the system 100. In some embodiments, the purchase monitor 102 can provide the purchase information to the database manager 114 on the system 100. Alternatively, the purchase monitor 102 can provide the purchase information to a remote database accessible to the system 100.

As mentioned above, the system 100 can further include an attribute identifier 104 for identifying one or more attributes associated with the monitored purchases. In particular, the attribute identifier 104 can identify one or more product attributes 116 and one or more user attributes 118 from the purchase information. In some embodiments, the attribute identifier 104 can identify at least one product attribute and at least one user attribute for each monitored purchase. Additionally or alternatively, the attribute identifier 104 can identify multiple user attributes and multiple product attributes for each monitored purchase.

The attribute identifier 104 can identify product attributes and user attributes from information associated with the purchase identified by purchase monitor 102, from a product profile associated with the purchased product, and/or from a user profile associated with the purchasing user. In some embodiments, the product attributes and user attributes for each purchase are provided to the attribute identifier 104 by a merchant, a user, and/or other source. Alternatively, the attribute identifier 104 can parse the purchase information and extract or otherwise identify one or more product attributes and/or one or more associated user attributes from each purchase. For example, the attribute identifier can examine the raw data associated with the monitored purchases and identify both product attributes and associated user attributes from each purchase.

In some embodiments, the attribute identifier 104 can access or otherwise obtain the product attributes and user attributes from different sources. For example, as described above, the attribute identifier 104 can receive or otherwise identify the product attributes from the information associated with the monitored purchases. With respect to the user attributes, however, the attribute identifier 104 may receive or otherwise identify the user attributes associated with a particular purchase from user information available to the system 100 (e.g., from a social networking system). For example, the attribute identifier 104 can identify user attributes associated with a particular product or purchase from a user profile, newsfeed, or monitored user activity with respect to a social networking system. Alternatively, the attribute identifier 104 can identify user attributes based on accessing information on a third-party server or other source.

In some embodiments, identifying the product attributes and user attributes can include associating one or more product attributes with one or more user attributes. In particular, the attribute identifier 104 can associate each product attribute for a purchase to each user attribute for the same purchase. In some embodiments, the attribute identifier 104 can store the product attributes and user attributes within a database. The attribute identifier 104 can store each product attribute together with one or more associated user attributes. Additionally or alternatively, the attribute identifier 104 can store each user attribute together with one or more associated product attributes.

In addition to identifying and associating the product attributes and the user attributes, the attribute identifier 104 can store and/or otherwise maintain the product attributes and user attributes (e.g., in a database). In particular, for each monitored purchase, the attribute identifier 104 can store one or more product attributes and one or more corresponding user attributes associated with each respective purchase.

As mentioned above, the system 100 can further include a correlation manager 106 for determining attribute correlations 120 between product attributes and user attributes. In particular, the correlation manager 106 can determine attribute correlations between one or more product attributes and associated user attributes based on the identified product attributes and user attributes associated with the monitored purchases. In some embodiments, the correlation manager 106 can determine an attribute correlation between a single product attribute and a single user attribute. It is also appreciated that the correlation manager 106 can determine attribute correlations between any number of product attributes and any number of user attributes. For example, the correlation manager 106 can determine an attribute correlation 120 between a single product attribute and a combination of user attributes. In addition, the correlation manager 106 can determine an attribute correlation between a combination of product attributes and a single user attribute. Furthermore, the correlation manager 106 can determine an attribute correlation between a combination of product attributes and a combination of user attributes.

Determining attribute correlations 120 can include determining that one or more product attributes have a positive correlation (e.g., a correlation indicating a likelihood of interest) with one or more respective user attributes. In particular, based on a history of monitored purchases and associated attributes, the correlation manager 106 can determine that a particular product attribute has a positive correlation with a particular user attribute if users having the particular user attribute often purchase products having the particular product attribute. Alternatively, the correlation manager 106 can determine that a particular product attribute has a negative correlation (e.g., a correlation indicating a likelihood of disinterest) with a particular user attribute. For example, based on a history of purchases associated with a particular product attribute, the correlation manager may determine that users having the particular user attribute very rarely purchase products having the particular product attribute. To illustrate the foregoing, where a first user attribute is “male gender” and a second user attribute is “female gender,” the correlation manager 106 might determine, based on multiple purchases associated with a particular product attribute, that users having the first attribute (i.e., male users) are much more likely to purchase products having the particular product attribute than users having the second attribute (i.e., female users). Thus, the correlation manager 106 can determine that a positive correlation exists between the particular product attribute and the first user attribute and/or that a negative correlation exists between the particular product attribute and the second user attribute.

The correlation manager 106 can determine an attribute correlation between a product attribute and a user attribute in a variety of ways. For example, the correlation manager 106 can calculate a correlation score associated with a pairing of a product attribute and a user attribute and then determine an attribute correlation based on the calculated correlation score. The correlation manager 106 can utilize the calculated correlation score to determine whether there is a positive correlation (e.g., indicating a likelihood of interest when the product attribute and the user attribute are paired), a negative correlation (e.g., indicating a likelihood of disinterest when the product attribute and the user attribute are paired), or a neutral correlation (e.g., indicating neither a likelihood of interest nor a likelihood of disinterest when the product attribute and the user attribute are paired) between the product attribute and the user attribute. In one or more embodiments, a relatively high correlation score indicates a positive correlation between the product attribute and the user attribute, a relatively low correlation score indicates a negative correlation between the product attribute and the user attribute, and a relatively average score indicates a neutral correlation between the product attribute and the user attribute.

The correlation manager 106 can calculate a correlation score based on a number of factors. For example, the correlation manager 106 can calculate a correlation score for a particular attribute pairing between one or more product attributes and one or more user attributes based on a frequency of purchases associated with the particular pairing, a percentage of purchases of a product associated with the particular pairing, a total number of purchases associated with the particular pairing, a relative number or frequency of purchases associated with the particular pairing (e.g., with respect to one or more other attribute pairings), and/or any other statistics/data indicative of a correlation for the particular pairing. For instance, the correlation manager 106 can determine that a particular pairing of a product attribute and a user attribute has a higher frequency than pairings of the product attribute and other user attributes and thus assign the particular pairing a high correlation score (i.e., indicating a positive correlation between the product attribute and the user attribute). In some embodiments, the correlation manager 106 can determine a correlation score for a pairing of a single product attribute and a single user attribute. Alternatively, the correlation manager 106 can determine a correlation score for a pairing of any number of product attributes and any number of user attributes. For example, the correlation manager 106 may determine that a single product attribute does not have a positive correlation with a first user attribute alone or with a second user attribute alone (e.g., users having only one or the other of the first and second user attribute are not likely to purchase a product having the product attribute), but may determine that the single product attribute has a positive correlation with a combination of the first and second user attributes (e.g., users having both the first and second user attributes are likely to purchase a product having the product attribute).

In one or more embodiments, the correlation manager 106 can determine whether a correlation score satisfies a threshold correlation score. In particular, the correlation manager 106 can compare the correlation score to a threshold score to determine whether the correlation score is greater than or equal to a threshold correlation to determine whether a positive, negative, or neutral correlation exists between a product attribute and a corresponding user attribute. For example, the correlation manager 106 can determine that a correlation score above a certain threshold value indicates a high likelihood that a user with an identified user attribute or combination of user attributes will purchase a product having an identified product attribute or combination of product attributes. Alternatively, if the correlation score is below the threshold value, the correlation manager 106 may determine that a user with an identified user attribute is unlikely to purchase a product having an identified product attribute.

In some embodiments, the correlation manager 106 can compare the correlation score to multiple threshold values. In particular, different threshold values may indicate varying levels of likelihood that a user having a particular user attribute or combination of user attributes will purchase a product having a particular product attribute or combination of product attributes. For example, different thresholds may correspond to different levels of correlation between attributes. For instance, a correlation score at or below a low threshold value may indicate a trivial or zero correlation between a product attribute and a user attribute. A correlation score at or above the low threshold may indicate a weak or low correlation between a product attribute and a user attribute. A correlation score at or above a medium threshold may indicate a moderate or medium correlation between a product attribute and a user attribute. A correlation score at or above a high threshold may indicate a strong or high correlation between a product attribute and a user attribute. In some embodiments, the correlation manager 106 may only consider a single threshold in determining an attribute correlation. Alternatively, the correlation manager 106 can consider any number of thresholds in determining an attribute correlation.

In some embodiments, the different threshold values can correspond to different ranges of correlation coefficients. In particular, in determining an attribute correlation 120 between product attributes and user attributes, the correlation manager 106 can determine a correlation coefficient associated with each pairing of one or more product attributes and one or more user attributes. The correlation manager 106 can further determine a range of values associated with each type of correlation. For example, a pairing of a product attribute and a user attribute having a correlation coefficient below 0.25 may indicate a trivial or zero correlation between the product attribute and the user attribute. A pairing of attributes having a correlation coefficient between 0.25 and 0.50 may indicate a low or weak correlation between the pairing of attributes. A pairing of attributes having a correlation coefficient between 0.50 and 0.75 may indicate a medium or moderate correlation between the pairing of attributes. A pairing of attributes having a correlation coefficient over 0.75 may indicate a high or strong correlation between the pairing of attributes. In some embodiments, the correlation manager 106 may consider other ranges of correlation coefficients in determining a positive correlation between product attributes and user attributes. Alternatively, the correlation manager 106 may consider various ranges of negative correlation coefficient values in determining whether a negative correlation exists between product attributes and user attributes.

In addition to determining different types and levels of correlation, the correlation manager 106 may also weigh product attributes and/or user attributes differently in determining one or more attribute correlations. In particular, the correlation manager 106 may consider different product attributes or user attributes as more important than other product attributes or user attributes in determining an attribute correlation. For example, where a first user attribute appears to contribute more heavily than a second user attribute in providing an indication that a user having the first and second user attributes will buy a product having a particular product attribute, the correlation manager 106 may give more weight to the first user attribute in determining an attribute correlation and/or calculating a correlation score associated with the attribute correlation. In other words, the correlation manager 106 may assign a higher correlation score to a pairing with the first user attribute than to a pairing with the second user attribute.

As mentioned above, the system 100 can further include a new product manager 108 for receiving information associated with a new product. In particular, the new product manager can receive one or more new product attributes associated with a new product. In some embodiments, the new product manager 108 can receive new product attributes from a merchant associated with a new product. Alternatively, the new product manager 108 can access one or more new product attributes on a third-party server and/or social networking system.

The new product can be any new product associated with a merchant. In particular, the new product can be a product having a limited or no purchase history, for which no direct user interest data is available. For example, a new product may include a recently developed, released, or launched product by a merchant for which the merchant has no purchase information. Alternatively, in some embodiments, the new product can include a product having a purchase history that is inaccessible to a merchant, system 100, or other interested party.

As mentioned above, the system 100 can further include a correlation identifier 110 for identifying attribute correlations associated with new product attributes. In particular, the correlation identifier 110 can identify at least one attribute correlation from the determined attribute correlations based on one or more new product attributes associated with the new product. For example, where a new product has a purchase price of twenty dollars, the correlation identifier 110 can identify one or more of the attribute correlations between other products having a product attribute corresponding to a purchase price of twenty dollars. In some embodiments, the correlation identifier 110 can identify all attribute correlations having a purchase price of twenty dollars (e.g., or a similar price to the new product). Alternatively, the correlation identifier 110 can identify only correlations associated with a similar purchase price to the new product in addition to one or more other product attributes (e.g., product type, product color, product category, etc.) similar to the attributes of the new product.

In some embodiments, rather than identifying all attribute correlations associated with a particular product attribute, the correlation identifier 110 can selectively identify an attribute correlation based on a score associated with the attribute correlation. For example, the correlation identifier 110 can identify one or more attribute correlations based on whether a correlation score associated with the attribute correlation exceeds a correlation threshold. In some embodiments, the correlation identifier 110 can identify all attribute correlations that exceed a threshold score. For example, the correlation identifier 110 can identify all attribute correlations that indicate a highly positive or strong correlation between one or more new product attributes and one or more user attributes. Alternatively, the correlation identifier 110 can selectively identify those attribute correlations having a correlation score that indicates a moderately strong correlation or higher between one or more new product attributes and one or more user attributes.

In some embodiments, the correlation identifier 110 can identify one or more attribute correlations that indicate the strongest correlation between one or more user attributes and one or a combination of the new product attributes. For example, the correlation identifier 110 can selectively identify an attribute correlation having the strongest correlation score associated with one or a combination of the new product attributes. Additionally or alternatively, the correlation identifier 110 can selectively identify a predetermined amount (e.g., 2, 3, 4) of attribute correlations having the highest/strongest correlation scores associated with one or more of the new product attributes.

As mentioned above, the system 100 can include a user identifier 112 for identifying one or more users that are likely to be interested in a new product based on the correlations identified by the correlation identifier 110. In particular, the user identifier 112 can identify a target group of users based on the identified attribute correlations between the new product attributes and one or more user attributes from the identified attribute correlations. For example, the user identifier 112 can identify a target group of users having a particular user attribute or combination of user attributes that have positive correlations with one or more of the new product attributes. In some embodiments, the target group of users can include a group of identified users of a social networking system. Alternatively, the target group of users can include one or more users that are not users of the social networking system.

The identified users may represent a group of users having a high likelihood of purchasing a new product. In particular, the identified users may each have a particular user attribute or combination of user attributes that have positive correlations with one or more attributes of the new product. In some embodiments, the user identifier 112 can identify a particular user attribute or combination of user attributes that indicate a propensity to purchase the new product. Thereafter, the user identifier 112 can analyze the attributes of a plurality of users to identify a specific target group of users having the particular user attribute or combination of user attributes.

In some examples, the user identifier 112 can selectively identify users based on a level of certainty associated with an interest of the identified users in the new product. For example, the user identifier 112 can select only those users associated with a predetermined correlation score and thus having a predicted level of likelihood of purchasing the new product based on one or more identified attribute correlations. In some embodiments, the user identifier 112 can select a particular number of users that have the highest likelihood of purchasing a new product. Alternatively, the user identifier 112 can select any number of users that satisfy a criteria or likelihood of interest in the new product.

In one or more embodiments, the user identifier 112 can calculate an aggregate correlation score or make a determination whether to include a user in a target group of users based on all correlations between the attributes of the user and the attributes of a new product. In particular, although a user may have a user attribute with a positive correlation to an attribute of the new product, the user may also have one or more other attributes with negative correlations to one or more attributes of the new product. Accordingly, the user identifier 112 can account for all the correlations—positive, negative, etc.—between a user's attributes and a new product's attributes in determining whether to include the user in a target group of users. In some embodiments, the user identifier 112 may exclude any users from the target group that have a negative correlation (e.g., a correlation below a certain threshold) with the new product. Accordingly, the user identifier 112 may only include users having positive correlations with the new product.

As mentioned above, the system 100 can include a database manager 114. The database manager 114 can manage storage of information and/or access to information on the social networking system, including information associated with various purchases and/or information about the purchases. Additionally, the database manager 110 can store and/or provide access to product attributes 116, user attributes 118, attribute correlations 120, and other information associated with purchases, users, and/or products. In some embodiments, the database manager 114 can store information associated with various users and products on a database accessible to the system 100 and/or one or more client devices.

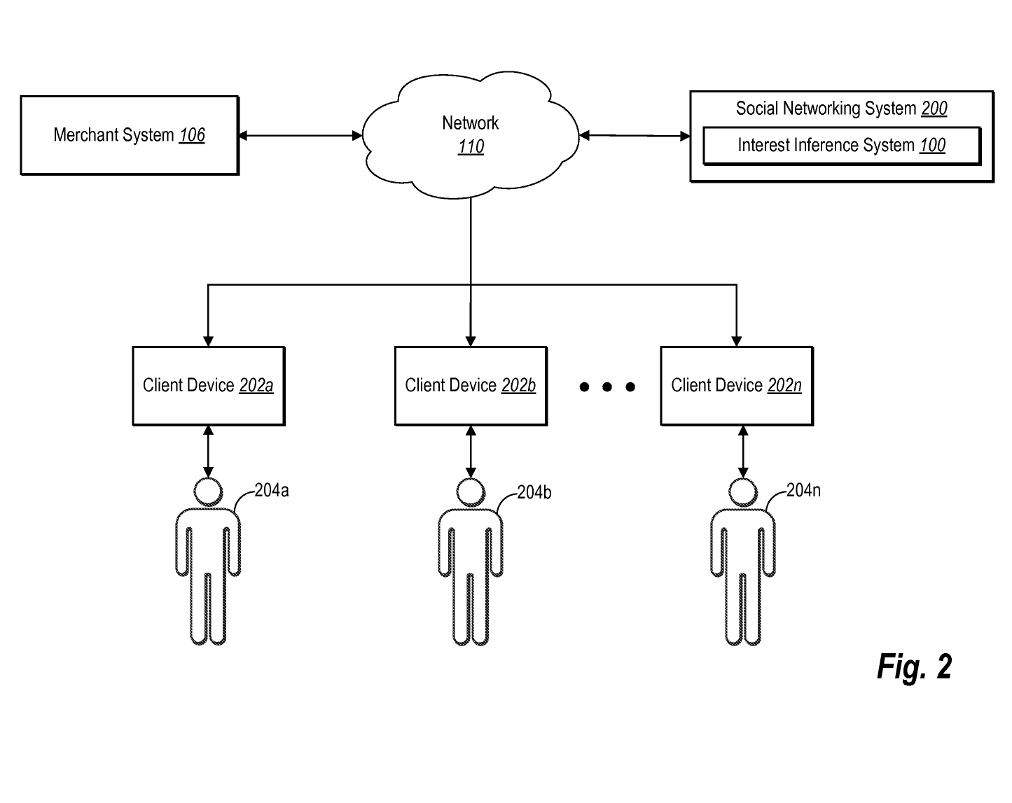

FIG. 2 illustrates a block diagram of an example environment for implementation of the interest inference system 100. In particular, FIG. 2 illustrates a social networking system 200 in communication with multiple client devices 202a-n and a merchant system 206. As shown, the client devices 202a-n may be associated with corresponding users 202a-n. The social networking system 200 can communicate with the client devices 202a-n and the merchant system 206 by way of a network 208. Additionally, the social networking system 200 can communicate with the merchant system 206 by way of the network 208. Alternatively, the social networking system 200 can communicate with the client devices 202a-n and/or the merchant system 206 by way of one or more additional networks.

In some embodiments, functions and features described herein can be performed entirely on the social networking system 200. For example, the system 100 may be implemented within the social networking system 200 and the social networking system 200 may be configured to provide the functionality and features described above with respect to the system 100. Alternatively, the client devices 202a and/or merchant system 206 can perform one or more functions described with respect to the system 100.

As illustrated in FIG. 2, the users 204a-n can communicate with the social networking system 200 by way of the client devices 202a-n. The client devices 202a-n can include various types of computing devices. For example, client device 202a can be a mobile device such as a mobile telephone, a smartphone, a PDA, a tablet, or a laptop, or a non-mobile device such as a desktop, server, or other computing device. Additional details with respect to client devices are discussed below with respect to FIG. 7.

As described above, the social networking system 200 can monitor purchases made by users 204a-n of the social networking system 200. For example, the social networking system 200 can receive information for purchases made by the users 204a-n using the client devices 202a-n. In some embodiments, the social networking system 200 can receive the information from interactions by the users 204a-n with the social networking system 200 (e.g., from purchases made using the social networking system 200). Otherwise, the social networking system 200 can receive purchase information from the client devices 202a-n, the merchant system 106, or any other source of information.

Additionally, the social networking system 200 can receive and/or identify product attributes and user attributes associated with the purchases by the users 204a-n. For example, the social networking system 204 can access a record of purchases made by users 204 of the social networking system 200 and identify corresponding product attributes 116 and user attributes 118 associated with each purchase. Furthermore, similar to the features and functionality described above in connection with the system 100 of FIG. 1, the social networking system 200 can determine attribute correlations 120 between product attributes 116 and user attributes 118.

To illustrate, the interest inference system 100 implemented within the social networking system 200 can monitor purchases of clothing and accessories by users 204a-n. In this example, the system 100 can identify product attributes such as price, brand, color, material, style, design, product type (e.g., clothing or accessory), whether a purchase is for clothing or accessories, or other descriptive attributes associated with the purchased products. For example, for a purchase of a Gucci handbag, the system 100 can identify product attributes such as “high-fashion brand,” “$1000,” “leather,” and “clothing accessory” as well as associated user attributes for the purchase such as “female” and “45 years old.” The system 100 can monitor other purchases, such as clothing and accessory purchases across various products, brands, and price ranges. For each purchase, the system 100 can identify various product attributes and user attributes. Based on these identified product attributes and user attributes, the system 100 can determine a correlation between different product attributes and user attributes. For example, the system 100 can identify that users having user attributes such as “40-50 years old,” “female,” and “$100,000-150,000 income” have a positive correlation to products having product attributes of “high-fashion brand” and “over $500.”

As another non-limiting example, the system 100 can monitor purchases of different beverages. In particular, the system 100 can identify purchases associated with soft drinks. In this example, the system 100 can identify product attributes such as “diet,” “non-diet,” “brand,” “canned,” “bottled,” “caffeinated,” or other characteristics associated with each product. Additionally, the system 100 can identify various user attributes such as “age,” “gender,” “profession,” or other characteristic associated with each user. Based on the identified characteristics, the system 100 may determine attribute correlations between one or more product attributes and user attributes. For example, the system 100 may determine a positive correlation between a combination of the user attributes of “male” and “30-40 years old” and a combination of the product attributes of “diet” and “caffeinated.” As another example, the system 100 may determine a positive correlation between the user attribute of “female” and the product attribute of “bottled” soft drinks.

As illustrated in FIG. 2, the merchant system 206 can communicate with the social networking system 200 by way of the network 208. For example, the merchant system 206 can be associated with an individual (e.g., human user), a business, a group, or other entity. Although FIG. 2 illustrates only one merchant system 206, it is understood that multiple merchant systems associated with multiple merchants can communicate with the social networking system 200. Further, similar to the client devices 202a-n, the merchant system 206 can include various types of computing devices. In particular, the merchant system 206 may include one or more server devices configured to provide marketing or e-commerce services to the merchant's customers.

In some embodiments, the merchant system 206 can provide information associated with a new product to the social networking system 200. In particular, the merchant system 206 can provide one or more new product attributes associated with the new product to the social networking system 200. In some embodiments, the merchant system 206 can provide new product attributes for a recently developed product associated with a merchant and for which the merchant has limited or no purchase information. Alternatively, the merchant system 206 can provide new product attributes for an existing product for which the merchant has limited or no purchase information.

Upon receiving the new product attributes, the social networking system 200 can identify one or more attribute correlations for the attributes of the new product based on past purchases of other products. In particular, the social networking system 200 can identify one or more attribute correlations based on monitored purchases of products having one or more of the same product attributes as the new product. Accordingly, the social networking system 200 can use the attribute correlations from the past purchases of other products to infer interest in the new product.

In one example, a merchant associated with a new product may desire to know whether users of the social networking system 200 will be interested in the new product (e.g., to gauge potential demand). For example, if the merchant is launching a new line black t-shirts, the merchant may utilize the features disclosed herein to gauge potential interest in the black t-shirts and/or identify a target group for marketing the black t-shirts. Thus, the merchant may provide attributes for the black t-shirts, such as “color:black,” “category:clothing,” “type:t-shirt,” “style:crew neck,” and/or any other attributes associated with the black t-shirts. Based on a record of purchases, the system 100 can identify one or more correlations between the attributes for the new product and users or user attributes.

Using identified correlations, the social networking system 200 can identify one or more users 204a-n of the social networking system 200 based on the identified correlation attributes. In particular, the social networking system 200 can identify a group of users from the users 204a-n based on identified correlation attributes between user attributes associated with the group of users and product attributes associated with monitored product attributes that are common to the new product. In some embodiments, the social networking system 200 can identify a group of users that, based on the correlation attributes, are expected to purchase or be otherwise interested in the new product.

In some embodiments, the social networking system 200 can provide information associated with the attribute correlations to the merchant system 206. For example, in some embodiments, the social networking system 200 can provide a merchant with one or more user attributes having a positive correlation with product attributes of the new product. Additionally or alternatively, the social networking system 200 can provide access to one or more user profiles and/or facilitate communication between the merchant system 206 and the identified group of users that are likely to be interested in the new product. In some embodiments, the merchant can provide marketing content to the group of users by way of the social networking system 200.

In some embodiments, the social networking system 200 can facilitate a marketing campaign for the new product by providing marketing content to a target group of users of the social networking system 200. For example, in response to receiving one or more new product attributes from a merchant system 206, the social networking system 200 can identify one or more correlations between the new product attributes and user attributes, identify potentially interested users having the correlated user attributes, and provide targeted marketing to the identified users. In some embodiments, the social networking system 200 can carry out the marketing campaign at the request of a merchant for the new product without providing any information (e.g., correlating user attributes or identities of potentially interested users) to the merchant system 200.

In some embodiments, rather than using attribute correlations to infer interest by known users in a new product, the social networking system 200 can utilize attribute correlations to infer interest by a new user in known products. For example, when a user registers with the social networking system 200 and provides personal information (i.e., user attributes), the social networking system 200 can identify attribute correlations for the provided user attributes and then identify one or more products with product attributes from the identified relevant attribute correlations. As such, the social networking system 200 can provide customized/targeted marketing to the user upon registration with the social networking system 200 without having any prior purchase history for the user. Further, the social networking system 200 may update, change, and/or add user attributes for the user as the user interacts with the social networking system 200 and provides additional personal information.

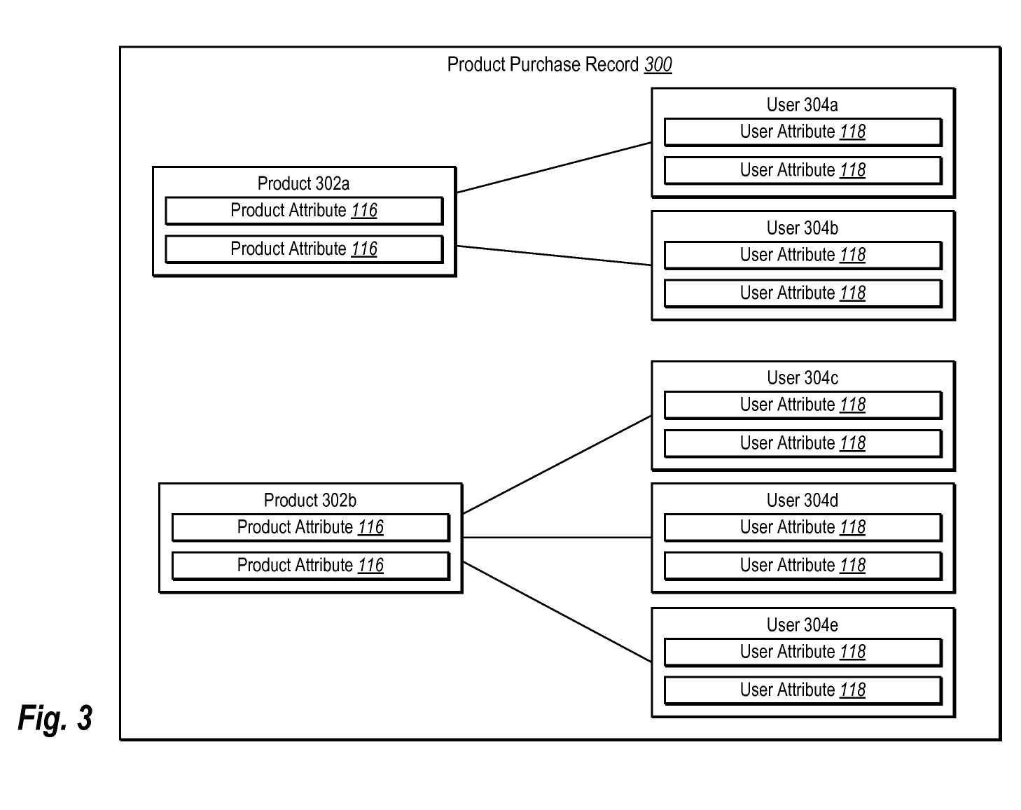

FIG. 3 illustrates a block diagram of an example product purchase record 300 in accordance with one or more embodiments of the present disclosure. In particular, the product purchase record 300 can include a record of purchase information associated with product purchases by users of the social networking system 200. For example, the product purchase record 300 includes information for purchases monitored by the system 100 described above in connection with FIGS. 1 and 2. In some embodiments, purchase information included within the purchase record 300 can include analyzed or partially analyzed data in which users, products, attributes, and/or other details are indexed, tagged, organized, itemized, or otherwise identified (e.g., by the social networking system 200) within the product purchase record 300. Additionally or alternatively, the purchase information included within the product purchase record 300 can include raw or unprocessed data that reflects purchase data as originally received or accessed by the social networking system 200.

As mentioned above, in some embodiments, the product purchase record 300 can include purchase information associated with various purchases by users of the social networking system 200. For example, the product purchase record 300 includes information for purchases of a product 302a by user 304a and user 304b, and purchases of a product 302b by user 304c, user 304d, and user 304e. As shown, each of products 302a-b can have one or more product attributes 116. Similarly, each of users 304a-e can have one or more user attributes 118. The product attributes 116 for product 302a may be different than, the same as, or partially overlap the product attributes 116 for product 302b. Similarly, the user attributes 118 of user 304a may be different than, the same as, or partially overlap the user attributes 118 of one or more of users 304b-e. Accordingly, each of the purchases may indicate one or more pairings between product attributes 116 and user attributes 118 that may be unique to the purchase or may be common to multiple purchases. In particular, each purchase may represent various attribute pairings including pairings between a single product attribute 116 and a single user attribute 118, pairings between a single product attribute 116 and multiple user attributes 118, pairings between multiple product attributes 116 and a single user attribute 118, and/or pairings between multiple product attributes 116 and multiple user attributes 118. The social networking system 200 can track, index, and/or otherwise store the various attribute pairings in order to identify attribute correlations as discussed above and as will be discussed in more detail below.

The product purchase record 300 can store and/or manage product attributes 116 and user attributes 118 in a variety of ways. For example, the product purchase record 300 can include a listing of products and associated users who have purchased the product or similar products. In some embodiments, the product purchase record 300 can include a listing of products and each associated user of the social networking system who has purchased the product. For example, as illustrated in FIG. 3, the product purchase record 300 can include a listing of products and each user of the social networking system 200 who has purchased the product. Additionally or alternatively, the product purchase record 300 can include a listing of users and each associated product purchased by the user.

As mentioned, the product purchase record 300 can include at least one product attribute 116 stored, indexed, or otherwise linked to a respective product. Additionally, the product purchase record 300 can include at least one user attribute 118 stored, indexed, or otherwise linked to a respective user. Alternatively, in some embodiments, the system 100 (e.g., correlation manager 106) can determine attribute correlations 120 from raw (e.g., unstructured) purchase data associated with the purchases.

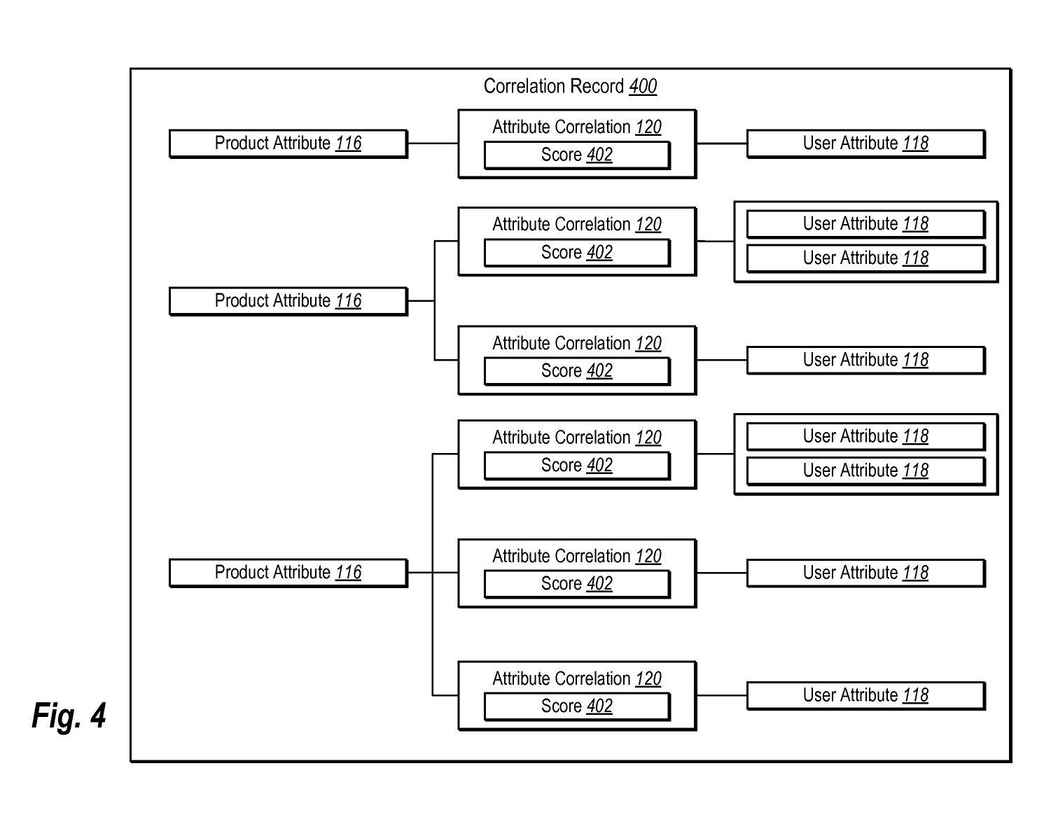

FIG. 4 illustrates a block diagram of an example correlation record 400 in accordance with one or more embodiments of the present disclosure. In particular, the correlation record 400 can include a record of attribute correlations 120 between one or more product attributes 116 and one or more user attributes 118. In some embodiments, the correlation record 400 can include attribute correlations 120 based the purchase information within the product purchase record 300 described above in connection with FIG. 3. Additionally, the correlation record 400 can include attribute correlations 120 based on purchase information obtained elsewhere.

As mentioned above, the correlation record 400 can include one or more attribute correlations 120 between one or more product attributes 116 and one or more user attributes 118. In particular, based on the purchase information, the correlation record 400 can include attribute correlations 120 between product attributes 116 and user attributes 118 that indicate a positive correlation between one or more product attributes 116 and one or more user attributes 118. In some embodiments, the attribute correlations 120 can represent various degrees of correlation between product attributes 116 and user attributes 118. For example, the correlation record 400 can include only attribute correlations 120 that represent one or more positive correlations between one or more product attributes 116 and one or more user attributes 118. Additionally or alternatively, the correlation record 400 can include attribute correlations 120 that indicate neutral correlations and/or negative correlations between one or more product attributes 116 and one or more user attributes 118. Although FIG. 4 illustrates correlations between product attributes 116 and user attributes 118, one will appreciate that the correlation record 400 can additionally or alternatively include correlations between one or more product attributes and one or more users generally (rather than specific attributes of the users) to indicate a correlation between the particular product attribute and the user without regard for the specific attributes of the user.

In some embodiments, the correlation record 400 can include an indication of a degree or strength of attribute correlations 120. In particular, each attribute correlation 120 can include or be associated with a correlation score 402 based on a strength of correlation between the corresponding product attribute(s) 116 and user attribute(s) 118. For example, the correlation score 402 can indicate whether an attribute correlation 120 is a weak correlation, a moderate correlation, or a strong correlation. Additionally or alternatively, the correlation score 402 can indicate whether an attribute correlation 120 is a positive or a negative correlation as discussed in more detail above.

As illustrated in FIG. 4, the correlation record 400 can include multiple attribute correlations 120 between product attributes 116 and respective user attributes 118. In particular, the correlation record 400 can include one or multiple attribute correlations 120 between a product attribute 116 and one or more combinations of user attributes 118. In some embodiments, the correlation record 400 can include a listing of product attributes 116 or combinations of product attributes 116 and each attribute correlation 120 associated with each listed product attribute 116 or combination of product attributes 116. Additionally, while FIG. 4 illustrates correlation attributes 120 associated with individual product attributes 116, it is appreciated that the correlation record 400 can include correlation attributes 120 between user attributes 118 and combinations of product attributes 116. In other words, as explained in more detail herein, an attribute correlation 120 may exist between any number of product attributes 116 on the one hand and any number of user attributes 118 on the other. To illustrate, as shown in FIG. 4, the correlation record 400 can include an attribute correlation 120 associating the single product attribute 116 and a single corresponding user attribute 118; an attribute correlation 120 between a single product attribute 116 and a combination of user attributes 118; multiple attribute correlation 120 between a product attribute 116 and various individual and/or combinations of user attributes; and/or another attribute correlations 120 between product attributes 116 and user attributes 118. Moreover, as shown in FIG. 4, each of the attribute correlations 120 can include a score 402 associated with each respective attribute correlation 120.

As illustrated in FIG. 4, the correlation record 400 can provide the attribute correlations 120 between product attributes 116 and user attributes 118 via a listing of product attributes 116 and associated attribute correlations 120. Alternatively, the correlation record 400 can include a table, indexed data, or other organization of data associated with the attribute correlations 120. For example, in some embodiments, the correlation record 400 can include a table of values, including product attributes 116, user attributes 118, attribute correlations 120, scores 402, and other data that the system 100 can reference in identifying attributes 116, 118, attribute correlations 120, and/or scores 402.

Utilizing the correlation record 400, the system 100 and/or the social networking system 200 can provide marketing insights to merchants that want to market and/or gauge interest in a new product. In particular, the system can identify attributes of the new product, identify attribute correlations for the new product attributes from the correlation record, and identify corresponding users and/or user attributes correlated to the new product attributes. Accordingly, the system 100 can provide the merchant with valuable marketing information that is specific to the new product even without having past purchase information for the new product. In addition, the system 100 can identify users (e.g., users of the social networking system 200) that are likely to be interested in the new product, thereby allowing the merchant to efficiently target users with marketing content, rather than broadcasting marketing content to all or a larger group of users.

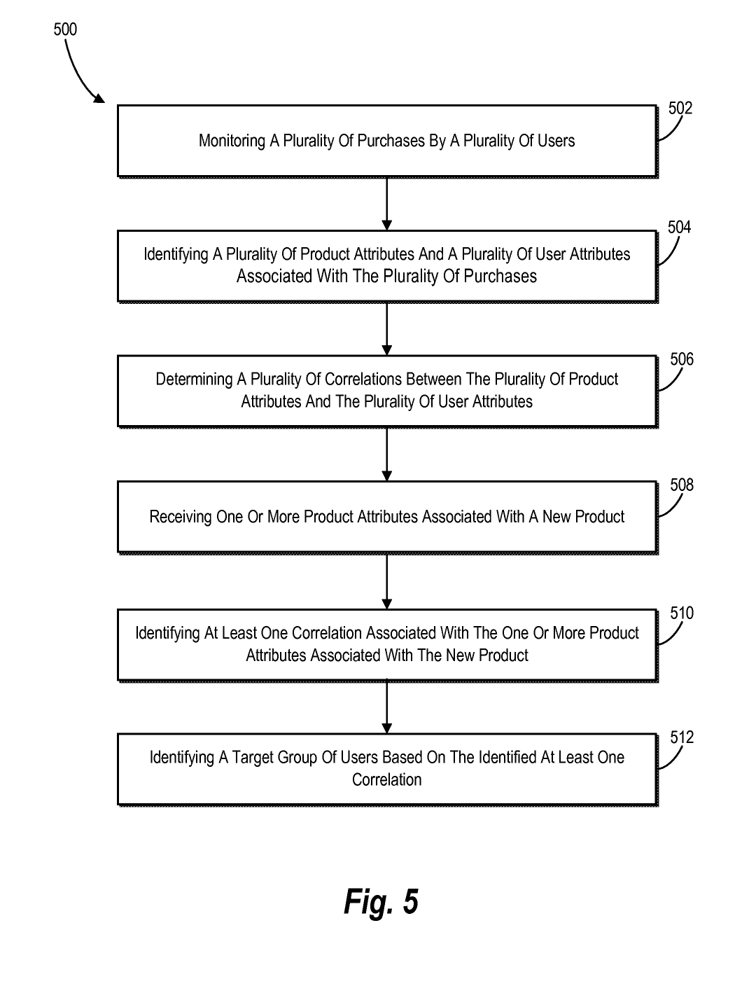

FIG. 5 illustrates a flowchart of an exemplary method 500 for inferring product interest in accordance with one or more principles described herein. While FIG. 5 illustrates example steps according to one embodiment, other embodiments may omit, add to, reorder, and/or modify any of the steps shown in FIG. 5. One or more steps shown in FIG. 5 may be performed by one or more components of the interest inference system 100 illustrated in FIG. 1. Further, one or more steps of the method 500 can be performed by the social networking system 200, client devices 202, merchant system 206, or a combination of different devices and systems.

As illustrated in FIG. 5, the method 500 includes step 502, which may include monitoring a plurality of purchases by a plurality of users. In particular, the system 100 can monitor a plurality of purchases by a plurality of users of the social networking system 200. For example, the system 100 can receive, access, or otherwise obtain purchase information associated with various purchases by users of the social networking system 200 and store the purchase information in a database. In some embodiments, the plurality of purchases can include purchases made by users using the social networking system 200. Alternatively, the plurality of purchases can include purchases made by the users through one or more third party systems.

As illustrated in FIG. 5, the method 500 further includes step 504, which may include identifying a plurality of product attributes and a plurality of user attributes associated with the plurality of purchases. In particular, the system 100 can identify product attributes and user attributes associated with a plurality of purchases by the users of the social networking system 200. In some embodiments, the system 100 can store the product attributes and user attributes in a product purchase record accessible to the social networking system 200. In some embodiments, the user characteristics may be derived from interactions of the plurality of users with a social networking system 200.

As illustrated in FIG. 5, the method 500 further includes step 506, which may include determining a plurality of attribute correlations between the plurality of product attributes and the plurality of user attributes. For example, system 100 can determine, based on the identified plurality of product attributes and the identified plurality of user attributes, a plurality of correlations between the plurality of product attributes and the plurality of user attributes. In particular, the system 100 can determine the attribute correlations between the product attributes and the user attributes in any suitable manner, such as explained herein. In some embodiments, determining the attribute correlations can include identifying one or more product attributes having a positive correlation with one or more user attributes. The correlations can include a correlation between a combination of product attributes and a single user attribute. Further, the correlations can include a correlation between a single product attribute and a combination of user attributes. Further, the correlations can include a correlation between a combination of product attributes and a combination of user attributes. Further the correlations can include a correlation between a single product attribute and a single user attribute.

In some embodiments, determining attribute correlations can include identifying one or more negative correlations between one or more product attributes and one or more user attributes. In some embodiments, the attribute correlations may be based on calculated correlation scores. For example, determining the correlations can include calculating correlation scores for each pairing between one or more product attributes and one or more user attributes represented by a purchase. Additionally, determining the plurality of attribute correlations can include determining levels of correlation for each pairing between one or more product attributes and one or more user attributes represented by a purchase (e.g., based on the correlation scores). Further, determining the plurality of attribute correlations can include calculating a correlation score for each pairing between one or more product attributes and one or more user attributes represented by a purchase. In some embodiments, the correlation score can include an aggregate correlation score based on multiple correlations between one or more product attributes and one or more user attributes. Moreover, in some embodiments, determining the plurality of attribute correlations can include identifying correlation scores above a threshold value.

In some embodiments, determining attribute correlations 120 can include determining that one or more product attributes from the identified product attributes corresponds to one or more user attributes from the identified user attributes 118. Furthermore, determining that one or more product attributes correspond to the one or more user attributes includes determining that a user having the one or more user attributes has a propensity to purchase a product (e.g., a new product) having the corresponding one or more product attributes.

The method further includes step 508, which may include receiving one or more product attributes associated with a new product. In particular, the system 100 can receive the new product attributes from a merchant associated with the new product. In some embodiments, the system 100 can receive the new product attributes from the merchant system 206.

The method further includes step 510, which may include identifying at least one correlation associated with the one or more product attributes associated with the new product. In particular, the system 100 can identify at least one attribute correlation that is associated with the one or more product attributes of the new product. In some embodiments, the system 100 can identify at least one attribute correlation based on a combination of the new product attributes.

The method further includes step 512, which may include identifying a target group of users based on the identified at least one correlation. In particular, the system 100 can identify a target group of users of the social networking system 200 having one or more user attributes associated with the at least one correlation. In some embodiments, identifying the target group of users is based on a determination that the users from the target group of users are likely to be interested in the new product based on the identified at least one correlation. For example, identifying a target group of users may include identifying one or more users of a social networking system having one or more user attributes associated with a correlation. In addition, the target group may be identified based on a determination that the associated correlation has a correlation score that exceeds a threshold correlation score.

Furthermore, while not illustrated in FIG. 5, the method 500 can include fewer or additional steps. For example, the method 500 can include providing one or more user attributes of the identified group of users to a merchant or merchant system associated with the new product. Additionally, the method 500 can include providing marketing content to the target group of users for the new product. In some embodiments, the social networking system 200 can provide the marketing content to the target group of users. Alternatively, the merchant system 206 can provide the marketing content to the target group of users (e.g., through the social networking system 200).

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) could be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the interest inference system 100. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 can comprise a social networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social-networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia content items to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations and identities of other users.

FIG. 7 illustrates an example network environment 700 of a social-networking system. Network environment 700 includes a client system 706, a social-networking system 702, and a third-party system 708 connected to each other by a network 704. Although FIG. 7 illustrates a particular arrangement of client system 706, social-networking system 702, third-party system 708, and network 704, this disclosure contemplates any suitable arrangement of client system 706, social-networking system 702, third-party system 708, and network 704. As an example and not by way of limitation, two or more of client system 706, social-networking system 702, and third-party system 708 may be connected to each other directly, bypassing network 704. As another example, two or more of client system 706, social-networking system 702, and third-party system 708 may be physically or logically co-located with each other in whole or in part. Moreover, although FIG. 7 illustrates a particular number of client systems 706, social-networking systems 702, third-party systems 708, and networks 704, this disclosure contemplates any suitable number of client systems 706, social-networking systems 702, third-party systems 708, and networks 704. As an example and not by way of limitation, network environment 700 may include multiple client system 706, social-networking systems 702, third-party systems 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client system 706, social-networking system 702, and third-party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client system 706 may be an electronic device including hardware, software, or embedded logic components or a combination of two or more such components and capable of carrying out the appropriate functionalities implemented or supported by client system 706. As an example and not by way of limitation, a client system 706 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 706. A client system 706 may enable a network user at client system 706 to access network 704. A client system 706 may enable its user to communicate with other users at other client systems 706.

In particular embodiments, client system 706 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 706 may enter a Uniform Resource Locator (URL) or other address directing the web browser to a particular server (such as server, or a server associated with a third-party system 708), and the web browser may generate a Hyper Text Transfer Protocol (HTTP) request and communicate the HTTP request to server. The server may accept the HTTP request and communicate to client system 706 one or more Hyper Text Markup Language (HTML) files responsive to the HTTP request. Client system 706 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 702 may be a network-addressable computing system that can host an online social network. Social-networking system 702 may generate, store, receive, and send social-networking data, such as, for example, user-profile data, concept-profile data, social-graph information, or other suitable data related to the online social network. Social-networking system 702 may be accessed by the other components of network environment 700 either directly or via network 704. In particular embodiments, social-networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social-networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 706, a social-networking system 702, or a third-party system 708 to manage, retrieve, modify, add, or delete, the information stored in data store.

In particular embodiments, social-networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social-networking system 702 may provide users of the online social network the ability to communicate and interact with other users. In particular embodiments, users may join the online social network via social-networking system 702 and then add connections (e.g., relationships) to a number of other users of social-networking system 702 whom they want to be connected to. Herein, the term “friend” may refer to any other user of social-networking system 702 with whom a user has formed a connection, association, or relationship via social-networking system 702.

In particular embodiments, social-networking system 702 may provide users with the ability to take actions on various types of items or objects, supported by social-networking system 702. As an example and not by way of limitation, the items and objects may include groups or social networks to which users of social-networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 702 or by an external system of third-party system 708, which is separate from social-networking system 702 and coupled to social-networking system 702 via a network 704.

In particular embodiments, social-networking system 702 may be capable of linking a variety of entities. As an example and not by way of limitation, social-networking system 702 may enable users to interact with each other as well as receive content from third-party systems 708 or other entities, or to allow users to interact with these entities through an application programming interfaces (API) or other communication channels.

In particular embodiments, a third-party system 708 may include one or more types of servers, one or more data stores, one or more interfaces, including but not limited to APIs, one or more web services, one or more content sources, one or more networks, or any other suitable components, e.g., that servers may communicate with. A third-party system 708 may be operated by a different entity from an entity operating social-networking system 702. In particular embodiments, however, social-networking system 702 and third-party systems 708 may operate in conjunction with each other to provide social-networking services to users of social-networking system 702 or third-party systems 708. In this sense, social-networking system 702 may provide a platform, or backbone, which other systems, such as third-party systems 708, may use to provide social-networking services and functionality to users across the Internet.

In particular embodiments, a third-party system 708 may include a third-party content object provider. A third-party content object provider may include one or more sources of content objects, which may be communicated to a client system 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 702 also includes user-generated content objects, which may enhance a user's interactions with social-networking system 702. User-generated content may include anything a user can add, upload, send, or “post” to social-networking system 702. As an example and not by way of limitation, a user communicates posts to social-networking system 702 from a client system 706. Posts may include data such as status updates or other textual data, location information, photos, videos, links, music or other similar data or media. Content may also be added to social-networking system 702 by a third-party through a “communication channel,” such as a newsfeed or stream.

In particular embodiments, social-networking system 702 may include a variety of servers, sub-systems, programs, modules, logs, and data stores. In particular embodiments, social-networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 702 may also include suitable components such as network interfaces, security mechanisms, load balancers, failover servers, management-and-network-operations consoles, other suitable components, or any suitable combination thereof. In particular embodiments, social-networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 702 to one or more client systems 706 or one or more third-party system 708 via network 704. The web server may include a mail server or other messaging functionality for receiving and routing messages between social-networking system 702 and one or more client systems 706. An API-request server may allow a third-party system 708 to access information from social-networking system 702 by calling one or more APIs. An action logger may be used to receive communications from a web server about a user's actions on or off social-networking system 702. In conjunction with the action log, a third-party-content-object log may be maintained of user exposures to third-party-content objects. A notification controller may provide information regarding content objects to a client system 706. Information may be pushed to a client system 706 as notifications, or information may be pulled from client system 706 responsive to a request received from client system 706. Authorization servers may be used to enforce one or more privacy settings of the users of social-networking system 702. A privacy setting of a user determines how particular information associated with a user can be shared. The authorization server may allow users to opt in to or opt out of having their actions logged by social-networking system 702 or shared with other systems (e.g., third-party system 708), such as, for example, by setting appropriate privacy settings. Third-party-content-object stores may be used to store content objects received from third parties, such as a third-party system 708. Location stores may be used for storing location information received from client systems 706 associated with users. Advertisement-pricing modules may combine social information, the current time, location information, or other suitable information to provide relevant advertisements, in the form of notifications, to a user.

FIG. 8 illustrates example social graph 800. In particular embodiments, social-networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social-networking system 702, client system 706, or third-party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of social-networking system 702. As an example and not by way of limitation, a user may be an individual (human user), an entity (e.g., an enterprise, business, or third-party application), or a group (e.g., of individuals or entities) that interacts or communicates with or over social-networking system 702. In particular embodiments, when a user registers for an account with social-networking system 702, social-networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social-networking system 702. In particular embodiments, a user node 802 may be associated with information provided by a user or information gathered by various systems, including social-networking system 702. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 702 or a third-party website associated with a web-application server); a product (such as, for example, a product purchased by one or more users); an entity (such as, for example, a person, business, group, sports team, or celebrity); a resource (such as, for example, an audio file, video file, digital photo, text file, structured document, or application) which may be located within social-networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social-networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social-networking system 702. Profile pages may also be hosted on third-party websites associated with a third-party server 708. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 708. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 706 to send to social-networking system 702 a message indicating the user's action. In response to the message, social-networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social-networking system 702 may send a “friend request” to the second user. If the second user confirms the “friend request,” social-networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, subscriber relationship, superior/subordinate relationship, a purchase of a product by a user, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to a edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social-networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social-networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social-networking system 702 may create an edge 806 between a user node 802 and a concept node 804 in social graph 800. As an example and not by way of limitation, a user viewing a concept-profile page (such as, for example, by using a web browser or a special-purpose application hosted by the user's client system 706) may indicate that he or she likes the concept represented by the concept node 804 by clicking or selecting a “Like” icon, which may cause the user's client system 706 to send to social-networking system 702 a message indicating the user's liking of the concept associated with the concept-profile page. In response to the message, social-networking system 702 may create an edge 806 between user node 802 associated with the user and concept node 804, as illustrated by “like” edge 806 between the user and concept node 804. In particular embodiments, social-networking system 702 may store an edge 806 in one or more data stores. In particular embodiments, an edge 806 may be automatically formed by social-networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 702) or RSVP (e.g., through social-networking system 702) to an event associated with the advertisement. In addition or as an alternative, an advertisement may include social-networking-system context directed to the user. As an example and not by way of limitation, an advertisement may display information about a friend of the user within social-networking system 702 who has taken an action associated with the subject matter of the advertisement.

In particular embodiments, social-networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 708 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 702 may calculate a coefficient based on a user's actions. Social-networking system 702 may monitor such actions on the online social network, on a third-party system 708, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 702 may calculate a coefficient based on the user's actions with particular types of content. The content may be associated with the online social network, a third-party system 708, or another suitable system. The content may include users, profile pages, posts, news stories, headlines, instant messages, chat room conversations, emails, advertisements, pictures, video, music, other suitable objects, or any combination thereof. Social-networking system 702 may analyze a user's actions to determine whether one or more of the actions indicate an affinity for subject matter, content, other users, and so forth. As an example and not by way of limitation, if a user may make frequently posts content related to “coffee” or variants thereof, social-networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 702 may calculate a coefficient based on the type of relationship between particular objects. Referencing the social graph 800, social-networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 702 may determine that the user has a higher coefficient with respect to the first photo than the second photo because having a tagged-in-type relationship with content may be assigned a higher weight and/or rating than having a like-type relationship with content. In particular embodiments, social-networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 702 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social-networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 706 of the user). A first user may be more interested in other users or concepts that are closer to the first user. As an example and not by way of limitation, if a user is one mile from an airport and two miles from a gas station, social-networking system 702 may determine that the user has a higher coefficient for the airport than the gas station based on the proximity of the airport to the user.

In particular embodiments, social-networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 702 may provide information that is relevant to user's interests and current circumstances, increasing the likelihood that they will find such information of interest. In particular embodiments, social-networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 708 (e.g., via an API or other communication channel), or from another suitable system. In response to the request, social-networking system 702 may calculate the coefficient (or access the coefficient information if it has previously been calculated and stored). In particular embodiments, social-networking system 702 may measure an affinity with respect to a particular process. Different processes (both internal and external to the online social network) may request a coefficient for a particular object or set of objects. Social-networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social-networking system 702 or shared with other systems (e.g., third-party system 708). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 708, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system 702 may send a request to the data store for the object. The request may identify the user associated with the request and may only be sent to the user (or a client system 706 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
monitoring, using at least one processor, a plurality of purchases by a plurality of users;
identifying a plurality of product attributes and a plurality of user attributes associated with the plurality of purchases;
determining, based on the identified plurality of product attributes and the identified plurality of user attributes, a plurality of correlations between the plurality of product attributes and the plurality of user attributes;
receiving, from a merchant associated with a new product, one or more product attributes associated with the new product;
identifying, from the plurality of determined correlations, at least one correlation associated with the one or more product attributes associated with the new product; and
identifying, for the new product, a target group of users based on the identified at least one correlation.

2. The method of claim 1, wherein the plurality of users comprises a plurality of users of a social networking system.

3. The method of claim 1, further comprising providing user attributes associated with the target group of users to a merchant associated with the new product.

4. The method of claim 1, further comprising providing marketing content to the target group of users for the new product using a social networking system.

5. The method of claim 1, wherein the plurality of purchases comprises one or more purchases made by the plurality of users through a social networking system.

6. The method of claim 1, wherein the plurality of correlations comprises a correlation between a combination of product attributes and a single user attribute.

7. The method of claim 1, wherein the plurality of correlations comprises a correlation between a single product attribute and a combination of user attributes.

8. The method of claim 1, wherein the plurality of correlations comprises a correlation between a combination of product attributes and a combination of user attributes.

9. The method of claim 1, wherein the plurality of correlations comprises a correlation between a single product attribute and a single user attribute.

10. The method of claim 1, wherein determining the plurality of correlations comprises calculating correlation scores for each pairing between one or more product attributes and one or more user attributes represented by a purchase.

11. The method of claim 10, wherein determining the plurality of correlations further comprises determining levels of correlation for each pairing between one or more product attributes and one or more user attributes represented by a purchase.

12. The method of claim 10, wherein determining the plurality of correlations further comprises calculating a correlation score for each pairing between one or more product attributes and one or more user attributes represented by a purchase.

13. The method of claim 12, wherein the correlation score comprises an aggregate correlation score based on multiple correlations between one or more product attributes and one or more user attributes.

14. The method of claim 1, wherein the at least one correlation indicates a propensity to purchase the new product.

15. The method of claim 1, wherein identifying the target group of users is based on a determination that the users from the target group of users are likely to be interested in the new product on the identified at least one correlation.

16. The method of claim 1, wherein the plurality of user attributes comprise one or more user characteristics derived from interactions of the plurality of users with a social networking system.

17. A system comprising:
at least one processor; and
at least one non-transitory computer readable storage medium storing instructions thereon that, when executed by the at least one processor, cause the system to:
monitor a plurality of purchases by a plurality of users;
identify a plurality of product attributes and a plurality of user attributes associated with the plurality of purchases;
determine, based on the identified plurality of product attributes and the identified plurality of user attributes, a plurality of correlations between the plurality of product attributes and the plurality of user attributes;
receive, from a merchant associated with a new product, one or more product attributes associated with the new product;
identify, from the plurality of determined correlations, at least one correlation associated with the one or more product attributes associated with the new product; and
identify, for the new product, a target group of users based on the identified at least one correlation.

18. The system of claim 17, wherein the instructions further cause the system to calculate a correlation score associated with the at least one correlation.

19. The system of claim 18, wherein the instructions further cause the system to determine whether the correlation score exceeds a threshold correlation value associated with a likelihood of interest in the new product.

20. The system of claim 19, wherein identifying the target group of users comprises identifying one or more users of the plurality of users having one or more user attributes associated with the identified at least one correlation.
